(19) United States
(12) Patent Application Publication
(10) Pub. No.: US 2008/0093151 A1
(43) Pub. Date: Apr. 24, 2008

(54) Articulate Vehicle Having Exhaust Pipe Device Deformable According to Oscillation and Swing of Vehicle Body

(75) Inventors: Satoshi Ogawa, Tochigi (JP); Hiroyuki Igusa, Tochigi (JP); Qian Ye, Tochigi (JP)

Correspondence Address: POSZ LAW GROUP, PLC, 12040 SOUTH LAKES DRIVE, SUITE 101, RESTON, VA, 20191, US

(73) Assignee: KOMATSU LTD., Minato-ku, Tokyo (JP)

(21) Appl. No.: 11/795,022

(22) PCT Filed: Jan. 13, 2006
(86) PCT No.: PCT/JP06/00381

§ 371 Date: Jul. 10, 2007

(30) Foreign Application Priority Data
Jan. 14, 2005 (JP) 2005-007056

(51) Int. Cl. B60K 13/04; B62D 61/00; F16L 27/00

(52) U.S. Cl. 180/296; 180/21; 285/144.1; 280/420; 60/322; 180/309; 180/68.3

(57) ABSTRACT

An exhaust pipe device 20 of an articulate vehicle 1 has high durability. The exhaust pipe device 20 comprises a front exhaust pipe 21 fixed to a front vehicle body 2, a rear exhaust pipe 28 fixed to a rear vehicle body 3, and an intermediate exhaust pipe assembly 20T for interconnecting the front exhaust pipe 21 and the rear exhaust pipe 28. The intermediate exhaust pipe assembly 20T is rotatable around the vertical axis Y relative to the rear exhaust pipe 28, rotatable around the horizontal axis X2 relative to the front exhaust pipe 21, and expandable according to a change in a distance between the front exhaust pipe 21 and the rear exhaust pipe 28.

### TECHNICAL FIELD

The present invention relates to an articulate vehicle having a first and a second vehicle bodies interconnected by an articulate interconnecting device and particularly to an exhaust pipe device which is bridged between the first and the second vehicle bodies and deformable according to oscillation and swing of the first and the second vehicle bodies.

### BACKGROUND ART

As the exhaust pipe device of an articulate vehicle, there has been such a type that a muffler 110 installed at a vehicle body front portion 120 of an articulate vehicle 100 and an exhaust pipe 150 installed at a vehicle body rear option 130 are connected to each other in a flexible manner. This exhaust pipe device has double cylinder joints A1 and A2 capable of sliding and rotation in an air tight manner attached to an inflow port of an exhaust port of the muffler 110 and an inflow port of the exhaust pipe 150, respectively, and both the joints A1 and A2 are connected to each other by a flexible pipe 160.

In this type of articulate vehicle, a normally vertical rotating axis Y is provided at an interconnection portion between the vehicle body front portion 120 and the vehicle body rear portion 130, while a normally horizontal rotating axis X is provided in the longitudinal direction of the vehicle, and the vehicle body front portion 120 and the vehicle body rear portion 130 are enabled to relatively rotate around the horizontal axis X (that is, oscillation) so as to improve grounding performance of front and rear wheels during driving and stability of the vehicle body (See Patent Document 1, for example).

Patent Document 1: Japanese Utility Model Laid-Open No. 5-89830 (pages 2 to 5, FIGS. 1 to 3)

However, at a turn of the articulate vehicle 100, when the vehicle body is bent around the vertical axis Y, the double cylinder joint A2 coaxial with the vertical shaft Y is rotated. A force by which the double cylinder joint A2 is rotated is transmitted to the flexible pipe 160. Therefore, each time the articulate vehicle 100 makes a turn, a force of torsion or bending is applied to the flexible pipe 160 all the time, which lowers durability of the flexible pipe 160.

The present invention was made in view of the above problem and has an object to provide an exhaust pipe device of an articulate vehicle with high durability.

### SUMMARY OF THE INVENTION

An articulate vehicle according to the present invention comprises a first vehicle body; a second vehicle body; an interconnecting device for interconnecting the first and the second vehicle bodies; and an exhaust pipe device bridged between the first and the second vehicle bodies. The interconnecting device interconnects the first and the second vehicle bodies so that oscillation of the first or the second vehicle body relative to each other is possible around an oscillate axis which is perpendicular to an axle of the first or the second vehicle body and normally horizontal, and swing of the first or the second vehicle body relative to each other is also possible around a swing axis which is perpendicular to the oscillate axis and normally vertical. The exhaust pipe device is deformable according to the relative oscillation and swing of the first and the second vehicle bodies.

The exhaust pipe device body comprises a first exhaust pipe fixed to the first vehicle body; a second exhaust pipe fixed to the second vehicle body; and an intermediate exhaust pipe assembly interconnecting the first and the second exhaust pipes. The intermediate exhaust pipe assembly comprises a first intermediate exhaust pipe connected to the second exhaust pipe and rotatable coaxially with the swing axis with respect to the second exhaust pipe according to the relative swing of the first and the second vehicle bodies; and a second intermediate exhaust pipe extending in a direction not in parallel with the oscillate axis, connected to the first exhaust pipe and the first intermediate exhaust pipe and interconnecting the both pipes and expandable so as to change the length according to a change in a distance between the first exhaust pipe and the first intermediate exhaust pipe caused by the relative oscillation of the first and the second vehicle bodies.

In the articulate vehicle according to the present invention, at a turn of this vehicle by a steering operation, the first and the second vehicle bodies relatively swing around the swing axis and the entire vehicle body combining the first and the second vehicle bodies is bent at the position of the swing axis. At that time, in the exhaust pipe device, the first intermediate exhaust pipe of the intermediate exhaust pipe assembly is rotated coaxially with the swing axis with respect to the second exhaust pipe, by which the exhaust pipe device is also bent at the position of the swing axis. Also, during driving on an irregular road surface, the first and the second vehicle bodies relatively oscillate around the oscillate axis and the entire vehicle body is twisted. At that time, in the exhaust pipe device, a distance between the first exhaust pipe and the first intermediate exhaust pipe is changed, but according to the distance change, the second intermediate exhaust pipe is expanded/contracted. By the deformation action of the rotation and expansion/contraction of the plurality of intermediate exhaust pipes in the exhaust pipe device, a torsion force or bending force applied on each pipe is reduced. As a result, durability of the exhaust pipe device is improved.

In a preferred embodiment of the present invention, the interconnecting device has a hitch portion pivotally supported at its one end capable of oscillation around the oscillate axis relative to the first vehicle body and pivotally supported at the other end capable of swing around the swing axis relative to the second vehicle body. And the first intermediate exhaust pipe is fixed to the hitch portion. By this arrangement, when the first and the second vehicle bodies relatively swing, the swing force by which the first intermediate exhaust pipe swings with relative to the second vehicle body is directly applied from the hitch portion of the interconnecting device to the first intermediate exhaust pipe. The swing force directly applied from the hitch portion of the interconnecting device to the first intermediate pipe further reduces the torsion force or bending force applied to the exhaust pipe device when the exhaust pipe device is bent, which further improves the durability of the exhaust pipe device.

In a preferred embodiment of the present invention, the second intermediate exhaust pipe of the intermediate exhaust pipe assembly is rotatable around a first horizontal axis parallel with the oscillate axis relative to the first exhaust pipe according to the relative oscillation of the first and the second vehicle bodies and also rotatable around a second horizontal axis parallel with the oscillate axis relative to the first intermediate exhaust pipe. By this arrangement, the torsion force or bending force applied to the exhaust pipe device when oscillation occurs is further reduced, which further improves the durability of the exhaust pipe device.

As a specific example to make the above-mentioned second intermediate exhaust pipe expandable, in a preferred embodiment, a sliding joint made expandable by inserting one of two auxiliary exhaust pipes constituting the second intermediate exhaust pipe through the other in used, and in another embodiment, an expandable flexible tube is used for interconnecting the two auxiliary exhaust pipes.

In a preferred embodiment, the above-mentioned first vehicle body is a front vehicle body, and the above-mentioned second vehicle body is a rear vehicle body However, the present invention is not limited to that, but the above first vehicle body may be the rear vehicle body and the above second vehicle body may be the front vehicle body.

### BRIEF DESCRIPTION OF THE DRAWINGS

FIG. 1 is a side view of an articulate vehicle according to a first embodiment of the present inventing.

FIG. 2 is a side view of an exhaust pipe device of the articulate vehicle according to the first embodiment.

FIG. 3 is a partial sectional view of the exhaust pipe device of the articulate vehicle according to the first embodiment.

FIG. 4 is a partial sectional view of the exhaust pipe device of the articulate vehicle according to the first embodiment.

FIG. 5 is a side view of an exhaust pipe device of an articulate vehicle according to a second embodiment of the present invention.

FIG. 6 is a side view of an exhaust pipe device of a conventional articulate vehicle.

### BEST MODE FOR CARRYING OUT THE INVENTION

Several embodiments of an articulate vehicle having an exhaust pipe device according to the present invention will be described below referring to the attached drawings.

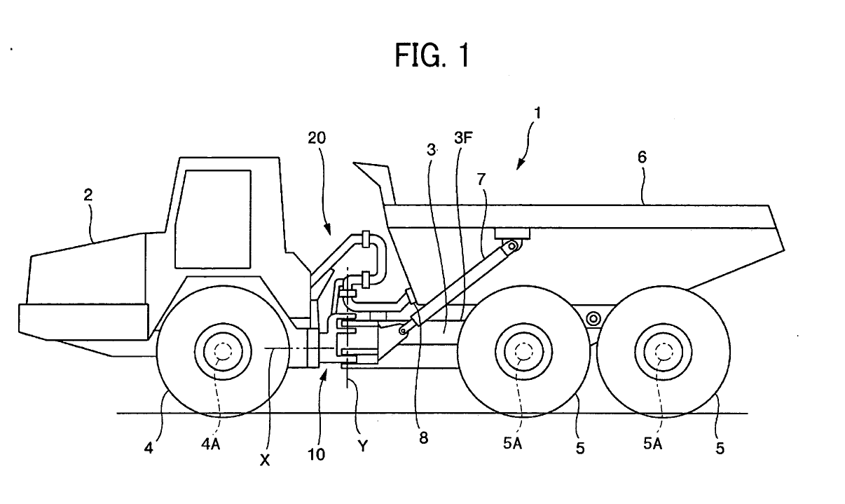

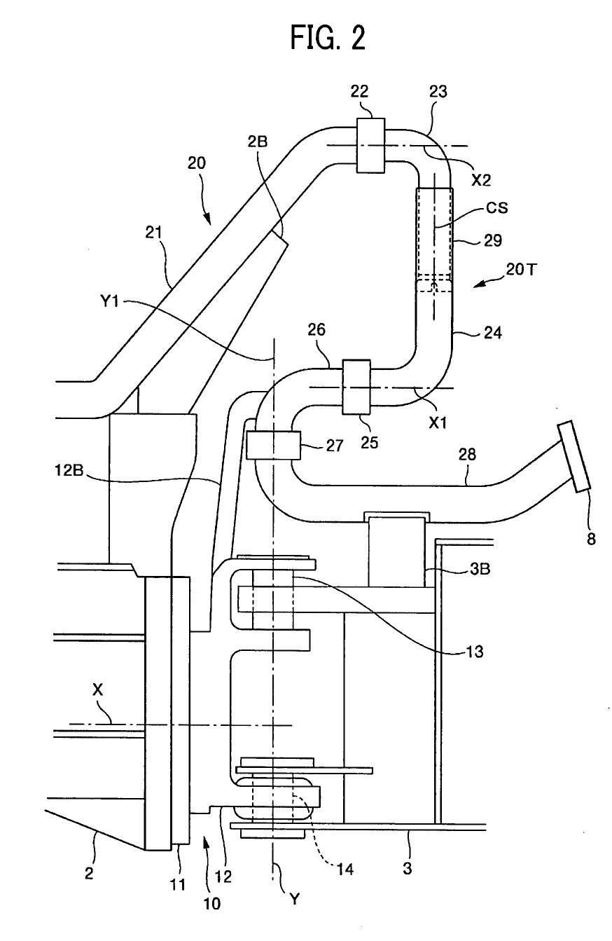

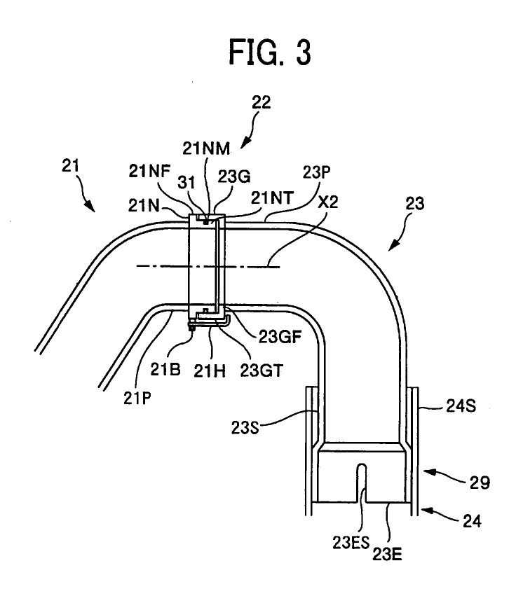

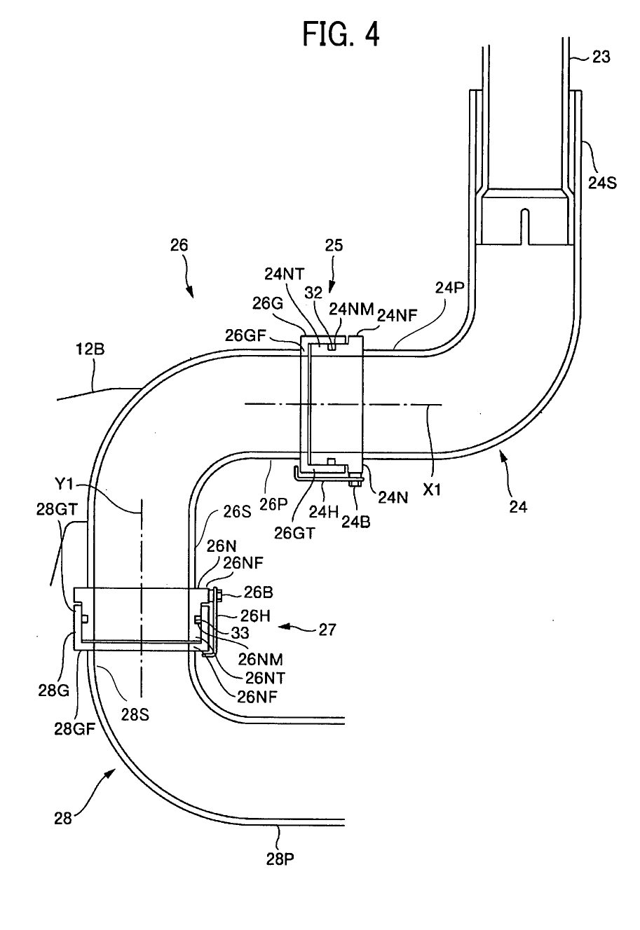

FIG. 1 shows a side view of an articulate vehicle according to a first embodiment of the present invention. FIG. 2 shows a side view of an exhaust pipe device of the articulate vehicle. FIGS. 3 and 4 show partial sectional views of the exhaust pipe device of the articulate vehicle.

As shown in FIG. 1, an articulate type dump tuck 1, which is one type of an articulate vehicle, has a front vehicle body 2 having a pair of front wheels 4 and a rear vehicle body 3 having two pairs of rear wheels 5, 5. The front vehicle body 2 and the rear vehicle body 3 are interconnected to each other by an interconnecting device 10. A cabin is provided at the front vehicle body 2, and a dump body 6 on which earth and sand are loaded is mounted on the rear vehicle body 3. When earth is to be dumped, the dump body 6 is rotated upward by a dump cylinder 7 to dump the earth to the rear.

At the front vehicle body 2, one end of the interconnecting device 10 is pivotally supported relative to the front vehicle body 2 capable of rotation (that is, oscillation) around the oscillate axis X which is perpendicular to the axle 4A of the pair of front wheels 4 and normally (that is, in the normal state where the dump truck 1 is placed on the horizontal and flat ground) horizontal, while the other end of the interconnecting device 10 is pivotally supported relative to the rear vehicle body 3 capable of rotation (that is, swing to right and left) around the swing axis Y which is perpendicular to the oscillate axis X and normally vertical.

When the articulate type dump truck 1 is to turn by a steering operation during driving, the front vehicle body 2 is made to swing around the swing axis Y to the right or left to make a turn by a steering cylinder, not shown. Therefore, the outer wheels are prevented from sinking due to application of an even load to both the right and left sides of the three pairs of wheels 4, 5, 5 at the turn of the dump truck 1, which enables stable driving even on a soft land under a severe condition, prevents falling of the vehicle and extends the tire life of the wheel.

The front vehicle body 2 and the rear vehicle body 3 are bridged by an exhaust pipe device 20. The front end of the exhaust pipe device 20 is connected to an exhaust port of an engine, not shown, on the front vehicle body 2, and an exhaust connecting device 8 is detachably connected to the front portion of the dump body 6 of the rear vehicle body 3.

When the dump body 6 is seated on a vehicle body frame 3F of the rear vehicle body 3, an exhaust gas of the engine passes through the exhaust pipe device 20, goes into the frame of the dump body 6 and is discharged from the rear portion of the dump body 6. The dump body 6 is warmed by heat of the exhaust gas in this way so as to prevent adhesion of earth and sand to the dump body 6 and to facilitate dumping of the earth. At the dumping when the dump body is raised, the rear end of the exhaust pipe device 20 and the front portion of the dump body 6 are separated from each other, and the exhaust gas is discharged from the rear end of the exhaust pipe device 20.

As shown in FIG. 2, a flange portion 11 of the interconnecting device 10 is fixed to the front vehicle body 2 by a bolt, not shown. The front portion of a hitch portion 12 of the interconnecting device 10 is connected to the flange portion 11 capable of rotation around the oscillate axis X with respect to the flange portion 11 by a bearing, not shown. Also, the rear portion of the hitch portion 12 of the interconnecting device 10 is connected to the rear vehicle body 14 capable of rotation around the swing axis Y with respect to the rear vehicle body by an upper pin 13 and a lower pin 14. In the interconnecting device 10, the front portion pivotally supported at the front vehicle body 2 constitutes a rotary joint for oscillation between the front vehicle body 2 and the rear vehicle body 3, while the rear portion pivotally supported by the rear vehicle body 3 constitutes a rotary joint for swing between the front vehicle body 2 and the rear vehicle body 3.

The exhaust pipe device 20 comprises a front exhaust pipe 21, a rear exhaust pipe 28, and an intermediate exhaust pipe assembly 20T interconnecting the front exhaust pipe 21 and the rear exhaust pipe 28. The intermediate exhaust pipe assembly 20T has a first auxiliary exhaust pipe 23, a second auxiliary exhaust pipe 24, and a third auxiliary exhaust pipe 26. The front exhaust pipe 21 is connected to the exhaust port of the engine, not shown, at its front end, extends from the engine rearward, rises up at the rear portion as shown in FIG. 2, and finally becomes parallel with the oscillate axis X in the vicinity of the rear end. The portion rising upward in the rear of the front exhaust pipe 21 is fixed to the front vehicle body 2 by a bracket 2B. The rear end of the front exhaust pipe 21 is connected to the first auxiliary exhaust pipe 23 by a first rotary joint 22. The first rotary joint 22 enables rotation of the first auxiliary exhaust pipe 23 relative to the front exhaust pipe 21 around a first horizontal axis X2 parallel with the oscillate axis X.

The first auxiliary exhaust pipe 23 is in the right-angle elbow shape and extends from the first rotary joint 22 rearward in parallel with the oscillate axis X and then, extends straight in the direction not in parallel with the oscillate axis X (typically, in the direction at a right angle to the oscillate axis X). The above portion extending straight of the first auxiliary exhaust pipe 23 (straight portion) is slidably inserted into the second auxiliary exhaust pipe 24 and constitutes a sliding joint portion 29 with variable length. The second auxiliary exhaust pipe 24 is in the right-angle elbow shape and a portion corresponding to the above sliding joint portion 29 extends straight in the extending direction of the straight portion of the first intermediate auxiliary pipe 23 and then, bends and extends to the front in parallel with the oscillate axis X. The end of the portion extended to the front of the second auxiliary exhaust pipe 24 is connected to the third auxiliary exhaust pipe 26 through the second rotary joint 25. The second rotary joint 25 makes the second auxiliary exhaust pipe 24 rotatable around a second horizontal axis X1 parallel with the oscillate axis X with respect to the third auxiliary exhaust pipe 26.

The third auxiliary exhaust pipe 26 is in the right-angle elbow shape and extends to the front in parallel with the oscillate axis X from the second rotary joint 25 and then, bends and goes downward along the swing axis Y. The end of the portion going below the third auxiliary exhaust pipe 26 is connected to the rear exhaust pipe 28 through a third rotary joint 27 at a position coaxial with the swing axis Y. The third rotary joint 27 makes the third auxiliary exhaust pipe 26 rotatable around the swing axis Y with respect to the rear exhaust pipe 28. The third auxiliary exhaust pipe 26 is fixed to the hitch portion 12 of the interconnecting device 10 by a bracket 12B at the bent spot. The front portion of the rear exhaust pipe 28 is in the right-angle elbow shape and goes downward along the swing axis Y from the third rotary joint 27 and then, bends and extends straight rearward. The rear portion of the rear exhaust pipe 28 bends from the above portion extended straight and rises up to the rear and then, is connected to an exhaust connecting device 8 at its rear end. The rear exhaust pipe 28 is fixed to the rear vehicle body 3 by a bracket 3B at its straight portion.

Next, interconnection of the plurality of exhaust pipes 21, 23, 24, 26, 28 in the exhaust pipe 20 will be described.

As shown in FIG. 3, a cylindrical inner-cylinder sleeve 21N is provided at the rear end of a portion 21P parallel with the oscillate axis X of the front exhaust pipe 21. The inner-cylinder sleeve 21N has a straight cylinder portion 21NT projecting rearward in parallel with the oscillate axis X and a flange portion 21NF projecting outward from the outer diameter of the straight cylinder portion 21NT at the base end side of the straight cylinder portion 21NT. On the outer circumferential surface of the straight cylinder portion 21NT, a ring groove 21NM is provided over the entire circumference. In the ring groove 21NM, a seal ring 31 is inserted. At the front end portion of a portion 23P extending in parallel with the oscillate axis X of the first auxiliary exhaust pipe 23, an outer-cylinder sleeve 23G in the cylindrical shape is provided. The outer-cylinder sleeve 23G has a straight cylinder portion 23GT projecting to the front in parallel with the oscillate axis X and a flange portion 23GF projecting inward from the inner diameter of the straight cylinder portion 23GT on the base end side of the straight cylinder portion 23GT.

The straight cylinder portion 21NT of the front exhaust pipe 21 is inserted into the straight portion 23GT of the first auxiliary exhaust pipe 23 and the both straight cylinder portions 21NT and 23GT are capable of relative rotation around the first horizontal axis X2 parallel with the oscillate axis X and sliding in the direction of the first horizontal axis X2. And the seal ring 31 seals a gap between the inner diameter of the straight cylinder portion 23GT and the outer diameter of the straight cylinder portion 21NT so that the exhaust gas inside does not leak to the outside.

On the outer circumferential surface of the flange portion 21NF of the front exhaust pipe 21, a plurality of hooks 21H are mounted at the base end portion by a bolt 21B. The hook 21H extends rearward from the flange portion 21NF, and its tip end portion bends inward in the L shape and is hooked by the rear end face of the outer-cylinder sleeve 23G, by which the front exhaust pipe 21 does not escape from the intermediate upper exhaust pipe 23. In this way, the inner-cylinder sleeve 21N and the outer-cylinder sleeve 23G constitute the first rotary joint 22.

As shown in FIG. 3, the lower end of a straight portion 23S of the first exhaust pipe 23 constitutes an inner slide portion 23E whose outer-diameter dimension is expanded from the other portions in a range of a predetermined length. A slit 23ES is provide at a plurality of spots in the circumferential direction of the inner slide portion 23E, and a cylindrical wall of the inner slide portion 23E is divided by the slits 23ES into a plurality of regions. The inner slide portion 23E is slidably inserted into the straight portion 24S of the second auxiliary exhaust pipe 24. Each region divided by the slits 23ES on the cylindrical wall of the inner slide portion 23E acts as a spring to expand outward within the straight portion 24S of the second auxiliary exhaust pipe 24, by which the outer circumferential surface of the inner slide portion 23E is brought into close contact with the inner circumferential surface of the straight portion 24S of the second auxiliary exhaust pipe 24 with an elastic pressure so that the exhaust gas does not leak to the outside. In this way, the inner slide portion 23E of the first auxiliary exhaust pipe 23 and the straight portion 24S of the second auxiliary exhaust pipe 24 constitute the expandable sliding joint portion 29, by which a portion formed by connection between the first and the second auxiliary exhaust pipes 23 and 24 in the intermediate exhaust pipe assembly 20T is capable of expansion/contraction in the direction of an axis CS (See FIG. 2) perpendicular to the oscillate axis X.

As shown in FIG. 4, at the front end of a portion 24P extending forward in parallel with the oscillate axis X of the second auxiliary exhaust pipe 24, a cylindrical inner-cylinder sleeve 24N is provided. The inner-cylinder sleeve 24N has a straight cylinder portion 24NT projecting forward in parallel with the oscillate axis X and a flange portion 24NF projecting outward from the outer diameter of the straight cylinder portion 24NT at the base end side of the straight cylinder portion 24NT. On the outer circumferential surface of the straight cylinder portion 24NT, a ring groove 24NM is provided over the entire circumference, and a seal ring 32 is inserted into the ring groove 24NM. At the rear end of a portion 26P extending rearward in parallel with the oscillate axis X of the third auxiliary exhaust pipe 26, a cylindrical outer-cylinder sleeve 26G is provided. The outer-cylinder sleeve 26G has a straight cylinder portion 26GT projecting rearward in parallel with the oscillate axis X and a flange portion 26GF projecting inward from the inner diameter of the straight cylinder portion 26GT at the base end side of the straight cylinder portion 26GT.

The straight cylinder portion 24NT of the second auxiliary exhaust pipe 24 is inserted into the straight cylinder portion 26GT of the third auxiliary exhaust pipe 26, and the both straight cylinder portions 24NT and 26GT are capable of rotation around the second horizontal axis X1 parallel with the oscillate axis X and sliding in the direction of the second horizontal axis X1. The seal ring 32 seals a gap between the both straight cylinder portions 26GT and 24NT so that the exhaust gas does not leak to the outside.

On the outer circumferential face of the flange portion 24NF of the second auxiliary exhaust pipe 24, a plurality of hooks 24H are mounted at the base end portion by a bolt 24B. The hook 24H extends forward, and its tip end portion bends in the L shape and is hooked by the front end face of the outer-cylinder sleeve 26G, by which the second auxiliary exhaust pipe 24 does not escape from the third auxiliary exhaust pipe 26. In this way, the inner-cylinder sleeve 24N of the second auxiliary exhaust pipe 24 and the outer-cylinder sleeve 26G of the third auxiliary exhaust pipe 26 constitute the second rotary joint 25.

At the lower end of a portion 26S extending downward along the swing axis Y of the third auxiliary exhaust pipe 26, a cylindrical inner-cylinder sleeve 26N is provided. The inner-cylinder sleeve 26N has a straight cylinder portion 26NT projecting downward along the swing axis Y and a flange portion 26NF projecting outward from the outer diameter of the straight cylinder portion 26NT at the base end side of the straight cylinder portion 26NT. On the outer circumferential surface of the straight cylinder portion 26NT, a ring groove 26NM is provided over the entire circumference, and a seal ring 33 is inserted into the ring groove 26NM. At the upper end of a portion 28S extending downward along the swing axis Y of the rear exhaust pipe 28, a cylindrical outer-cylinder sleeve 28G is provided. The outer-cylinder sleeve 28G has a straight cylinder portion 28GT projecting upward along the swing axis Y and a flange portion 28GF projecting inward from the inner diameter of the straight cylinder portion 28GT at the base end side of the straight cylinder portion 28GT.

The straight cylinder portion 26NT of the third auxiliary exhaust pipe 26 is inserted into the straight cylinder portion 28GT of the rear exhaust pipe 28, and the both straight cylinder portions 26NT and 28GT are capable of relative rotation around a vertical axis Y1 coaxial with the swing axis Y and sliding in the direction of the vertical axis Y1. The seal ring 33 seals a gap between the both straight cylinder portions 28GT and 26NT so that the exhaust gas does not leak to the outside.

On the outer circumferential face of the flange portion 26NF of the third auxiliary exhaust pipe 26, a plurality of hooks 26H are mounted at the base end portion by a bolt 26B. The hook 26H extends downward, and its tip end portion bends in the L shape and is hooked by the lower end face of the outer-cylinder sleeve 28G, by which the third auxiliary exhaust pipe 26 does not escape from the rear exhaust pipe 28. In this way, the inner-cylinder sleeve 26N of the third auxiliary exhaust pipe 26 and the outer-cylinder sleeve 28G of the rear exhaust pipe 28 constitute the third rotary joint 27.

As have been already explained and as shown in FIG. 2, the first horizontal axis X2 and the second horizontal axis X1 are parallel with the oscillate axis X and the vertical axis Y1 is coaxial with the swing axis Y.

Next, action of the exhaust pipe device 20 will be described.

Here, suppose that the front vehicle body 2 is rotated around the swing axis Y relative to the rear vehicle 3 and at the same time, the front vehicle body 2 is rotated around the oscillate axis X relative to the rear vehicle body 3. By rotation of the front vehicle body 2 around the swing axis Y, the third auxiliary exhaust pipe 26 in the intermediate exhaust pipe assembly 20T is directly applied with a rotating force from the hitch portion 12 of the interconnecting device 10 through the bracket 12B and is rotated around the third rotary joint 27 (around the vertical axis Y1 coaxial with the swing axis Y) along with the front vehicle body 2. Similarly, the front exhaust pipe 21, the first auxiliary exhaust pipe 23 and the second auxiliary exhaust pipe 24 are rotated with the front vehicle body 2. Also, by rotation of the front vehicle body 2 around the oscillate axis X, the front exhaust pipe 21 integral with the front vehicle body 2 is rotated. Then, with respect to the front exhaust pipe 21, the first auxiliary exhaust pipe 23 is rotated around the first rotary joint 22 (around the first horizontal axis X2) and the second auxiliary exhaust pipe 24 is also rotated around the second rotary joint 25 (around the second horizontal axis X1) with respect to the third auxiliary exhaust pipe 26. And a distance between the front exhaust pipe 21 and the third auxiliary exhaust pipe 26 is changed, but according to the change in the distance, the sliding joint portion 29 between the first auxiliary exhaust pipe 23 and the second auxiliary exhaust pipe 24 is expanded/contracted. Therefore, since compelling twisting force or bending force is not applied to any of the exhaust pipes 21, 23, 24, 26, 28 of the exhaust pipe device 20 and any of the rotary joints 22, 25, 27, durability of the exhaust pipe device 20 is improved.

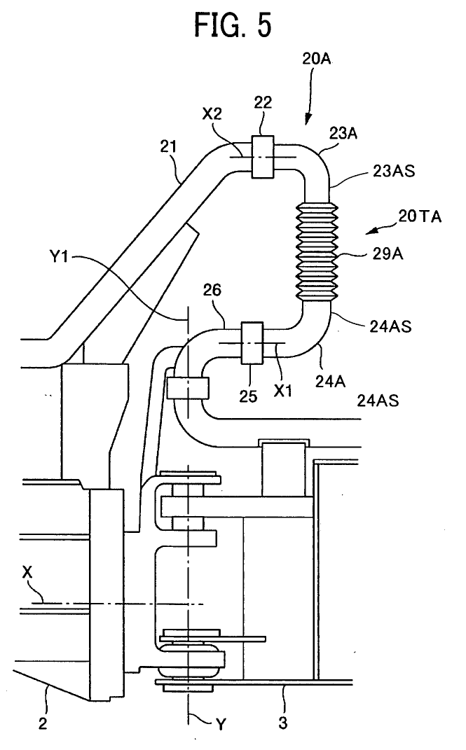

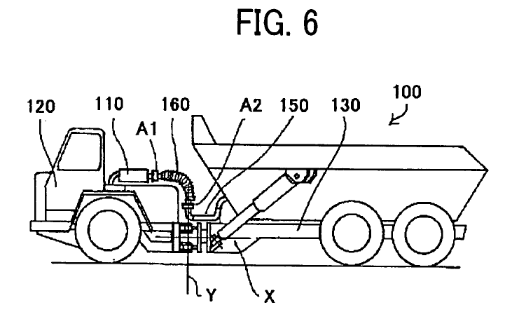

FIG. 5 is a side view of an exhaust pipe device of an articulate vehicle according to a second embodiment of the present invention. FIG. 6 shows a side view and a partial arrow view of the exhaust pipe device of the articulate vehicle.

As shown in FIG. 5, in this embodiment, in an intermediate exhaust pipe assembly 20TA of an exhaust pipe device 20A bridged between the front vehicle body 2 and the rear vehicle body 3, a portion 23AS extending perpendicularly to the oscillate axis X of a first auxiliary exhaust pipe 23A in the right-angle elbow shape and a portion 24AS extending perpendicularly to the oscillate axis X of a second auxiliary exhaust pipe 24A in the right-angle elbow shape are interconnected to each other via a flexible tube 29A which is capable of expansion/contraction and bending. The other constructions are the same as those of the above-mentioned first embodiment. Therefore, the action of the exhaust pipe device 20A when the front vehicle body 2 is rotated around the swing axis Y with respect to the rear vehicle body 3 is the same as that of the first embodiment. Also, when the front vehicle body 2 is rotated around the oscillate axis X with respect to the rear vehicle body 3, the flexible tube 29A is expanded/contracted according to the change in the distance between the front exhaust pipe 21 and the third auxiliary exhaust pipe 26.

As a variation, the range of the flexible tube 29A may be expanded to a spot where both or one of the first auxiliary exhaust pipe 23A and the second auxiliary exhaust pipe 24A may be bent at a right angle. Alternatively, both or one of the first rotary joint 22 or the second rotary joint 25 may be omitted and the first auxiliary exhaust pipe 23A and the front exhaust pipe 21 may be directly connected to each other and/or the second auxiliary exhaust pipe 24A and the third auxiliary exhaust pipe 26 may be directly connected to each other. Alternatively, the vertical position relation between the front exhaust pipe 21 and the rear exhaust pipe 28 may be contrary to that shown in FIGS. 1 and 2.

Two embodiments of the present invention have been described, but these embodiments are only examples for explaining the present invention and not intended to limit the range of the present invention to these embodiments. The present invention may be put into practice in other various forms, not departing from its gist. For example, in the dump truck 1 shown in FIG. 1, the interconnecting device 10 is made rotatable relative to the front vehicle body 2 around the oscillate axis X perpendicular to the axle of the front vehicle body and normally horizontal and also rotatable relative to the rear vehicle body 3 around the swing axis Y perpendicular to the oscillate axis X and normally vertical. However, there is an articulate vehicle in which the longitudinal relation of the interconnecting device is arranged inversely to the above. That is, in such a vehicle, the interconnecting device is capable of rotation around the oscillate axis perpendicular to an axle 5A of the rear vehicle body 3 and normally horizontal relative to the rear vehicle body 3 and also rotatable around the swing axis perpendicular to the oscillate axis and normally vertical relative to the front vehicle body 2. It is needless to say that the exhaust pipe device according to the principle of the present invention can be also applied to such an articulate vehicle. That is, in the configuration shown in FIG. 2, for example, the configuration of the exhaust pipe device 20 supposing that the vehicle body 3 is a front vehicle body, the vehicle body 2 is a rear vehicle body, the exhaust pipe 28 is a front exhaust pipe, and the exhaust pipe 20 is a rear exhaust pipe (or moreover, the upper limit relation between the exhaust pipe 28 and the exhaust pipe 20 is reversed) can be employed in such an articulate vehicle.

1. An articulate vehicle comprising:
a first vehicle body;
a second vehicle body;
an interconnecting device for interconnecting the first and the second vehicle bodies so that oscillation of the first or the second vehicle body relative to each other is possible around an oscillate axis which is perpendicular to an axle of the first or the second vehicle body and normally horizontal, and swing of the first or the second vehicle body relative to each other is also possible around a swing axis which is perpendicular to the oscillate axis and normally vertical; and
an exhaust pipe device which is bridged between the first and the second vehicle bodies and is deformable according to the relative oscillation and swing of the first and the second vehicle bodies, wherein
the exhaust pipe device has:
a first exhaust pipe fixed to the first vehicle body;
a second exhaust pipe fixed to the second vehicle body; and
an intermediate exhaust pipe assembly for interconnecting the first and the second exhaust pipes;
the intermediate exhaust pipe assembly has:
first intermediate exhaust pipes connected to the second exhaust pipe and capable of rotation coaxially with the swing axis with respect to the second exhaust pipe according to the relative swing of the first and the second vehicle bodies; and
second intermediate exhaust pipes extending in a direction not in parallel with the oscillate axis, connected at one end to the first exhaust pipe and at the other end to the first intermediate exhaust pipe, interconnecting the both pipes, and expandable so as to change length according to a change in a distance between the first exhaust pipe and the first intermediate exhaust pipe caused by the relative oscillation of the first and the second vehicle bodies.

2. The articulate vehicle according to claim 1, wherein
the interconnecting device has:
a hitch portion pivotally supported at one end capable of oscillation around the oscillate axis relative to the first vehicle body and also pivotally supported at the other end capable of swing around the swing axis relative to the second vehicle body and
the first intermediate exhaust pipe is fixed to the hitch portion of the interconnecting device, by which a swing force which makes the first intermediate exhaust pipe swing with respect to the second vehicle body when the first and the second vehicle bodies relatively swing is directly applied to the first intermediate exhaust pipe from the hitch portion.

3. The articulate vehicle according to claim 1, wherein
the second intermediate exhaust pipe is rotatable around a first horizontal axis parallel with the oscillate axis relative to the first exhaust pipe according to the relative oscillation of the first and the second vehicle bodies and also rotatable around a second horizontal axis parallel with the oscillate axis relative to the first intermediate exhaust pipe.

4. The articulate vehicle according to claim 3, wherein
the second intermediate exhaust pipe has:
a first auxiliary exhaust pipe connected rotatably around the first horizontal axis relative to the first exhaust pipe;
a second auxiliary exhaust pipe connected rotatably around the second horizontal axis relative to the first intermediate exhaust pipe; and
an expandable sliding joint interconnecting the first and the second auxiliary exhaust pipes so as to make a distance between the both auxiliary exhaust pipes variable.

5. The articulate vehicle according to claim 3, wherein
the second intermediate exhaust pipe has:
a first auxiliary exhaust pipe connected rotatably around the first horizontal axis relative to the first exhaust pipe;
a second auxiliary exhaust pipe connected rotatably around the second horizontal axis relative to the first intermediate exhaust pipe; and
an expandable flexible tube interconnecting the first and the second auxiliary exhaust pipes so as to make a distance between the both auxiliary exhaust pipes variable.

6. The articulate vehicle according to claim 1, wherein
the first vehicle body is a front vehicle body and the second vehicle body is a rear vehicle body.

7. The articulate vehicle according to claim 1, wherein
the first vehicle body is a rear vehicle body and the second vehicle body is a front vehicle body.
